(19) United States
(12) Patent Application Publication
(10) Pub. No.: US 2020/0090106 A1
(43) Pub. Date: Mar. 19, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Toshiaki NAKAHARA, Kanagawa (JP)

(73) Assignee: FUJI XEROX CO., LTD., Tokyo (JP)

(21) Appl. No.: 16/563,946

(22) Filed: Sep. 9, 2019

(30) Foreign Application Priority Data
Sep. 19, 2018 (JP) 2018-174998

(51) Int. Cl. G06Q 10/06

(52) U.S. Cl. CPC G06Q 10/063112; H04L 67/10

(57) ABSTRACT

An information processing apparatus includes a disclosure unit. The disclosure unit discloses the content of a request indicated by a first degree to a person with an ability indicated by a second degree in the case where the first degree which indicates the content of the request is equal to or less than the second degree which indicates the ability of the person who possibly undertakes the request.

### CROSS-REFERENCE TO RELATED APPLICATIONS

This application is based on and claims priority under 35 USC 119 from Japanese Patent Application No. 2018-174998 filed Sep. 19, 2018.

### BACKGROUND

### (i) Technical Field

The present disclosure relates to an information processing apparatus and a non-transitory computer readable medium.

### (ii) Related Art

Japanese Unexamined Patent Application Publication No. 2015-102996 addresses an issue of providing a technique of assisting efficient solicitation of contractors, and discloses a trader selection assisting device that includes: a trader information acquisition section that acquires information indicating achievements of a trader from a trader terminal of the trader who wishes to bid for a construction project; and a public solicitation processing section that calculates a predetermined evaluation point on the basis of the information indicating the achievements of the trader, and extracts the trader whose evaluation point is equal to or higher than a predetermined threshold as a subject who is requested for a quotation.

### SUMMARY

When performing a matching process between a person who makes a request and a person (contractor) who undertakes the request, an evaluation point is calculated from achievements of the contractor, and the contractor is requested for a quotation in the case where the evaluation point is equal to or higher than a threshold. Since the evaluation point is simply compared with the threshold, however, the content of the request may be disclosed to a third party that is not able to undertake the request.

Aspects of non-limiting embodiments of the present disclosure relate to providing an information processing apparatus and a non-transitory computer readable medium that avoid disclosure of the content of a request to a person who is not able to undertake the request.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a disclosure unit that discloses a content of a request indicated by a first degree to a person with an ability indicated by a second degree in a case where the first degree which indicates the content of the request is equal to or less than the second degree which indicates the ability of the person who possibly undertakes the request.

### BRIEF DESCRIPTION OF THE DRAWINGS

An exemplary embodiment of the present disclosure will be described in detail based on the following figures, wherein:

FIG. 1 is a conceptual module configuration diagram illustrating a configuration example according to an exemplary embodiment;

FIG. 2 illustrates a system configuration example that utilizes the exemplary embodiment;

FIG. 3 is a flowchart illustrating a process example according to the exemplary embodiment;

FIG. 4 illustrates a data structure example of a request information table;

FIG. 5 is a flowchart illustrating a process example according to the exemplary embodiment;

FIG. 6 illustrates a data structure example of a candidate ability information table;

FIG. 7 is a flowchart illustrating a process example according to the exemplary embodiment;

FIG. 8 illustrates a data structure example of a request weight table;

FIG. 9 is a flowchart illustrating a process example according to the exemplary embodiment;

FIG. 10 illustrates a data structure example of an ability weight table;

FIG. 11 is a flowchart illustrating a process example according to the exemplary embodiment;

FIG. 12 is a flowchart illustrating a process example according to the exemplary embodiment;

FIG. 13 illustrates a data structure example of a request information table;

FIG. 14 illustrates a data structure example of a candidate ability information table;

FIGS. 15A to 15E illustrate a process example according to the exemplary embodiment;

FIG. 16 is a flowchart illustrating a process example according to the exemplary embodiment;

FIG. 17 illustrates a data structure example of a correlation table;

FIGS. 18A to 18D illustrate a process example according to the exemplary embodiment; and

FIG. 19 is a block diagram illustrating a hardware configuration example of a computer that implements the exemplary embodiment.

### DETAILED DESCRIPTION

A preferable exemplary embodiment for implementing the present disclosure will be described below with reference to the drawings.

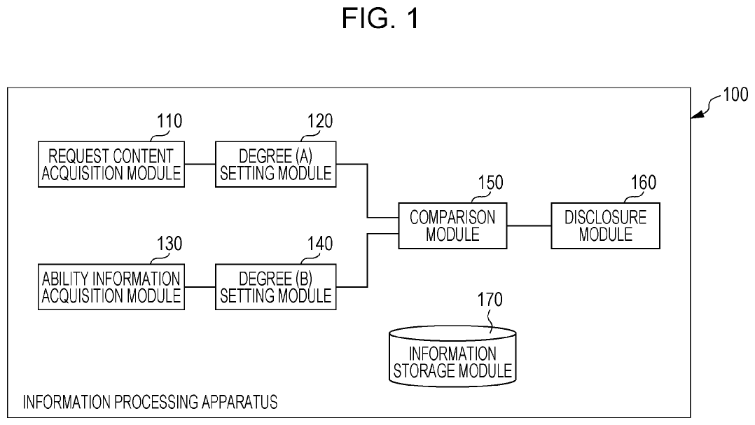

FIG. 1 is a conceptual module configuration diagram illustrating a configuration example according to an exemplary embodiment.

The term “module” generally refers to parts such as software (computer program) and hardware that are logically separable from each other. Thus, the modules in the exemplary embodiment include not only modules based on computer programs but also modules based on hardware components. Therefore, the exemplary embodiment also describes a computer program for causing a computer to function as such modules (a program for causing a computer to execute such procedures, a program for causing a computer to function as such units, and a program for causing a computer to implement such functions), a system, and a method. It should be noted, however, that language “store” and “cause . . . to store” and equivalent language is used for convenience of description. In the case where the exemplary embodiment describes a computer program, however, such language means to “cause a storage device to store” or “perform control so as to cause a storage device to store”. In addition, the modules may make one-to-one correspondence with the functions. In implementation, however, one module may be constituted of one program, a plurality of modules may be constituted of one program, or conversely one module may be constituted of a plurality of programs. In addition, a plurality of modules may be executed by one computer, or one module may be executed by a plurality of distributed or parallel computers. One module may include another module. In the following description, in addition, the term “connection” is used to indicate not only physical connections but also logical connections (for data exchange, instruction, data reference, log-in, etc.). The term “predetermined” means that the modificand has been determined before the target process, and may be used to mean that the modificand is determined in accordance with the situation or the state at the time, or the situation or the state in the past, before the target process even after the process according to the exemplary embodiment is started, not to mention before the process according to the exemplary embodiment is started. In the case where there are a plurality of “predetermined values”, such values may be different from each other, or two or more (or all, as a matter of course) of such values may be the same as each other. In addition, the wording “in the case where A, then B” is used to mean “it is determined whether or not A, and in the case where it is determined that A, then B”. It should be noted, however, that cases where it is not necessary to determine whether or not A are excluded. In the case where elements are listed as in “A, B, and C”, such listing is exemplary unless stated otherwise, and includes a case where only one of the elements (e.g. A alone) is selected.

In addition, the system or the device may be constituted of a plurality of computers, hardware, devices, etc. connected by a communication unit such as a network (including a one-to-one communication connection), or may be implemented by one computer, hardware, device, etc. The terms “device” and “system” are used as synonyms for each other. As a matter of course, the term “system” does not include mere social “schemes” (social systems) which are artificial arrangements.

In addition, after each process performed by each module, or after each of a plurality of processes performed in a module, target information is read from a storage device, and the result of the process is written into the storage device after the process is performed. Thus, reading from the storage device before the process and writing into the storage device after the process may not be described. Examples of the storage device may include a hard disk, a random access memory (RAM), an external storage medium, a storage device via a communication line, and a register in a central processing unit (CPU).

An information processing apparatus 100 according to the present exemplary embodiment discloses the content of a request to an appropriate party, and includes, as illustrated in the example in FIG. 1, a request content acquisition module 110, a degree (A) setting module 120, an ability information acquisition module 130, a degree (B) setting module 140, a comparison module 150, a disclosure module 160, and an information storage module 170. The information processing apparatus 100 performs a so-called matching process between a requester and a contractor.

The request content acquisition module 110 is connected to the degree (A) setting module 120. The request content acquisition module 110 acquires the content of a request and information on the request.

The “request” includes commission of a task. In the following description, commission of a task will be described as an example.

The degree (A) setting module 120 is connected to the request content acquisition module 110 and the comparison module 150. The degree (A) setting module 120 sets a first degree on the basis of the content of the request and the information on the request which are acquired by the request content acquisition module 110.

The “degree” (in the first degree or a second degree) may be a numerical value, and may be a symbol that indicates a level or the like (such as A, B, C, . . . , or α, β, γ, . . . , for example).

The “first degree” includes a numerical value that indicates an importance degree level, for example.

The degree (A) setting module 120 may use some or all of a requesting entity, confidentiality, a difficulty degree, a requested quality, a technological core, an estimated profit, an estimated sales amount, and a development scale as parameters to be taken into consideration when setting the first degree. The phrase “take into consideration” means “use”, and the first degree may be set using the confidentiality, difficulty degree, etc. The term “set” specifically includes calculating the first degree using a calculation formula that uses the confidentiality, difficulty degree, etc. as variables, a process of referencing an array (so-called look-up table) in which the confidentiality, difficulty degree, etc. are correlated with the first degree, etc.

The “difficulty degree” includes a development difficulty degree, for example.

The degree (A) setting module 120 may assign a weight to some or all of the parameters to be taken into consideration when setting the first degree.

The degree (A) setting module 120 may set the first degree using a value determined in advance in the case where the value of the parameters is not set.

Examples of the “case where the value of the parameters is not set” include a case where the value may not be set because of a shortage of information or the like.

The value determined in advance may be the lowest possible value of the parameter, for example.

The ability information acquisition module 130 is connected to the degree (B) setting module 140. The ability information acquisition module 130 acquires information on the ability of a person who possibly undertakes the request.

The “person who possibly undertakes the request” includes a public solicitation subject entity, a commission candidate, etc.

The “person” may be any person that is able to undertake the request, and may include juridical persons such as companies, individuals, groups, unincorporated associations, foundations, etc.

The “person who possibly undertakes the request” may include in-house departments of the company with the information processing apparatus 100 according to the present exemplary embodiment, subsidiaries, and affiliated companies.

The degree (D) setting module 140 is connected to the ability information acquisition module 130 and the comparison module 150. The degree (B) setting module 140 sets a second degree on the basis of the content of the request and the information on the request which are acquired by the ability information acquisition module 130.

The “second degree” includes a numerical value that indicates a reliability degree level, for example.

The degree (B) setting module 140 may use some or all of a credit degree, a technological capability, a product quality, an achievement, an ordered sales amount, a user evaluation, a third-party organization evaluation, and a financial standing as parameters to be taken into consideration when setting the second degree.

The “achievement” includes the number of received orders, for example.

The degree (B) setting module 140 may assign a weight to some or all of the parameters to be taken into consideration when setting the second degree.

The degree (B) setting module 140 may set the second degree using a value determined in advance in the case where the value of the parameters is not set.

Examples of the “case where the value of the parameters is not set” include a case where the value may not be set because of a shortage of information or the like.

The value determined in advance may be the lowest possible value of the parameter, for example.

The parameters to be taken into consideration when setting the second degree may be manually input by a provider of the information processing apparatus 100, acquired from data accumulated by the provider of the information processing apparatus 100, and/or acquired from data disclosed by a third party.

The comparison module 150 is connected to the degree (A) setting module 120, the degree (B) setting module 140, and the disclosure module 160. The comparison module 150 compares the first degree which is set by the degree (A) setting module 120 with the second degree which is set by the degree (B) setting module 140.

The comparison module 150 may use the first degree and the second degree that are the latest at the time of comparison when comparing the first degree and the second degree.

The comparison module 150 may use the second degree that is the latest at the time of comparison when comparing the first degree and the second degree in the case where the parameters to be taken into consideration when setting the second degree are acquired from data disclosed by a third party.

In the case where the parameters are acquired from data disclosed by a third party, it is difficult to grasp when the data are varied. Thus, the latest data are used in the case where the parameters are acquired from data disclosed by a third party. In the case where the parameters are manually input by the provider of the information processing apparatus 100 or acquired from data accumulated by the provider of the information processing apparatus 100, it is only necessary to change the first degree and the second degree when such data are varied. For the first degree, it is often good enough to use the first degree at the time of request.

The disclosure module 160 is connected to the comparison module 150. The disclosure module 160 discloses the content of a request indicated by the first degree to a person with an ability indicated by the second degree in the case where the first degree which indicates the content of the request is equal to or less than the second degree which indicates the ability of the person who possibly undertakes the request. That is, the disclosure module 160 discloses the content of a request with the first degree, which is equal to or less than the second degree as a result of the comparison module 150 making a comparison, to a person with the second degree.

The disclosure module 160 may limit disclosure subject entities in the case where some of the parameters to be taken into consideration when setting the first degree are higher than, or equal to or higher than, a threshold determined in advance.

The information storage module 170 stores the information which is acquired by the request content acquisition module 110 and the ability information acquisition module 130, the degrees which are set by the degree (A) setting module 120 and the degree (B) setting module 140, the result of the comparison process which is performed by the comparison module 150, the content which is disclosed by the disclosure module 160, information on the disclosure subject entity, etc. For example, the information storage module 170 stores a request information table 400, a candidate ability information table 600, a request weight table 800, an ability weight table 1000, a request information table 1300, a candidate ability information table 1400, a rating company (A) evaluation information table 1500, a candidate ability information table 1510, a rating company (B) evaluation information table 1520, a candidate ability information table 1530, a candidate ability information table 1540, a request information table 1800, a candidate ability information table 1820, and a comparison result table 1840 to be discussed later, etc.

The information storage module 170 also stores a correlation table in which the parameters to be taken into consideration when setting the first degree which indicates the content of a request are correlated with the parameters to be taken into consideration when setting the second degree which indicates the ability of a person who possibly undertakes the request. For example, the information storage module 170 stores a correlation table 1700.

In that case, the comparison module 150 compares the correlated parameters (the “parameter to be taken into consideration when setting the first degree” and the “parameter to be taken into consideration when setting the second degree”) with each other.

The term “compare” specifically refers to subtracting the “parameter to be taken into consideration when setting the second degree” from the “parameter to be taken into consideration when setting the first degree”.

Then, the comparison module 150 accumulates the comparison results.

The disclosure module 160 discloses the content of a request to a person with the second degree as the comparison target in the case where the accumulated value of the accumulated results is more than, or equal to or more than, a threshold determined in advance.

In the correlation table, correlation between the parameters (parameters used to set the first degree and parameters used to set the second degree) may be one-to-N correlation.

In that case, the comparison module 150 may make a comparison using the result of integrating the N parameters, among the parameters in which one parameter is correlated with N parameters, as distributed in proportions determined in advance.

The “one-to-N correlation” may be any of correlation between “one” parameter to be taken into consideration when setting the first degree and “N” (an integer of two or more) parameters to be taken into consideration when setting the second degree, and correlation between “N” parameters to be taken into consideration when setting the first degree and “one” parameter to be taken into consideration when setting the second degree.

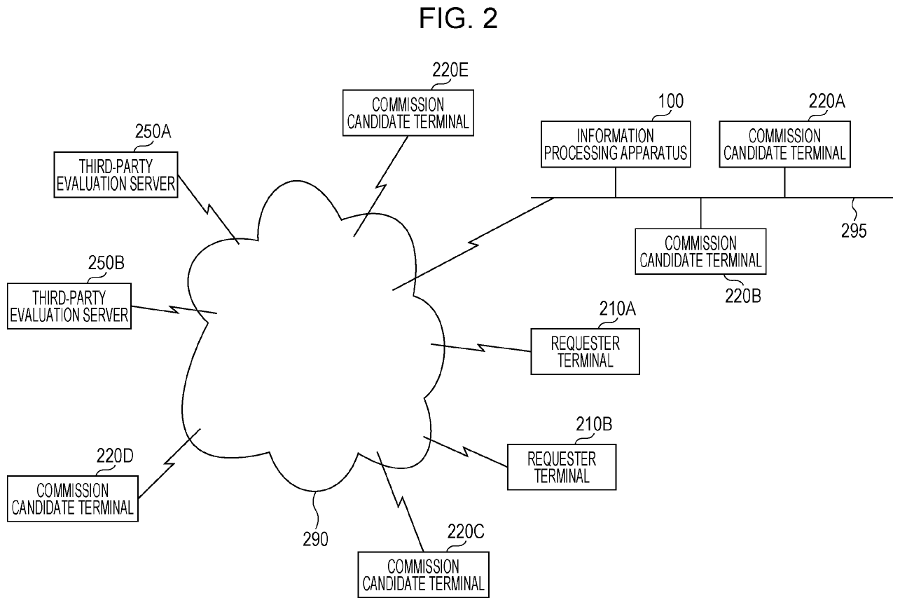

FIG. 2 illustrates a system configuration example that utilizes the exemplary embodiment.

The information processing apparatus 100, a commission candidate terminal 220A, and a commission candidate terminal 220B are connected to each other via a communication line 295.

The information processing apparatus 100, the commission candidate terminal 220A, and the commission candidate terminal 220B are connected to a requester terminal 210A, a requester terminal 210B, a commission candidate terminal 220C, a commission candidate terminal 220D, a commission candidate terminal 220E, a third-party evaluation server 250A, and a third-party evaluation server 250B via the communication line 295 and a communication line 290. The communication lines 290 and 295 may be wireless, wired, or a combination of both, and may be the Internet (an example of the communication line 290, in particular) as a communication infrastructure, an intranet (an example of the communication line 295, in particular), etc., for example.

The function of the information processing apparatus 100 may be implemented as a cloud service.

For example, the requester terminal 210 inputs information on commission of development (an example of the request) to the information processing apparatus 100 in accordance with an operation by the requester who is a user. On the other hand, the commission candidate terminal 220 inputs information on the ability of the commission candidate itself (an example of the request) to the information processing apparatus 100 in accordance with an operation by the commission candidate who is a user. The information processing apparatus 100 compares the first degree which indicates the content of the commission of development and the second degree which indicates the ability of the commission candidate, and discloses the content of the commission of development to the commission candidate who has an ability enough to accomplish the commission of development.

The information processing apparatus 100, the commission candidate terminal 220A, and the commission candidate terminal 220B, which are connected to the communication line 295, belong to an organization (typically a company) of the provider of the information processing apparatus 100 (or the provider of a service with the information processing apparatus 100), and an in-house department of the organization may also be a commission candidate (person who possibly undertakes the request).

The third-party evaluation server 250 evaluates and discloses the ability of the commission candidates (who do not have to be all the commission candidates, but who may include one or more “persons who possibly undertake the request” according to the present exemplary embodiment) of the commission candidate terminal 220. The information processing apparatus 100 acquires data disclosed by a third party as the “parameters to be taken into consideration when setting the second degree” from the third-party evaluation server 250.

In the present exemplary embodiment, the following processes are performed, for example. This description (in this paragraph and the next paragraph based on the paragraph number) is particularly made for the purpose of facilitating understanding of the present exemplary embodiment, and is not intended to limit the construction. It is a matter of course that the determination as to whether the disclosure to be patented is described in the Detailed Description (Patent Law Article 36(6)(i)) should not be made using only this description.

There has hitherto been a technique to evaluate public solicitation subject entities by digitalizing their achievements when publicly soliciting a development commission entity, and request a public solicitation subject entity whose digitalized value is equal to or more than a certain threshold for a quotation (see Japanese Unexamined Patent Application Publication No. 2015-102996, for example).

However, such a technique may not address a case where the confidentiality, profit rate, difficulty degree, requested quality, etc. differ among commission projects and it is desirable to choose a commission project, information on which is to be disclosed, in consideration of the credit degree etc. of a public solicitation subject entity, a case where a public solicitation is not issued in the first place and it is desirable that a development should be made in-house or by an affiliated subsidiary, or the like.

Thus, the information processing apparatus 100 is capable of disclosing information to an appropriate public solicitation subject entity (commission candidate terminal 220) in accordance with the confidentiality, profit rate, difficulty degree, requested quality, etc. of a commission project from the requester terminal 210.

For example, the information processing apparatus 100 performs the following processes.

(1) Digitalizes the importance degree level (an example of the first degree) in accordance with the content of a commission project, and digitalizes the reliability degree level (an example of the second degree) in accordance with the content of a public solicitation subject entity. Stores the respective digitalized levels. Compares the importance degree level of the commission project and the reliability degree level of the public solicitation subject entity. Discloses a commission project with an importance degree that is equal to or less than the reliability degree level of a public solicitation subject entity, as a result of the comparison, to the public solicitation subject entity.
(2) Some or all of the requesting entity, confidentiality degree, estimated profit, estimated sales amount, development scale, development difficulty degree, requested quality, and technological core degree may be used as parameters to be taken into consideration when setting the importance degree level of a commission project.
(3) Some or all of the number of received orders, ordered sales amount, product quality, user evaluation, third-party organization evaluation, and financial standing may be used as parameters to be taken into consideration when setting the reliability degree level of a public solicitation subject entity.
(4) A weight may be assigned to some or all of the parameters to be taken into consideration when setting the importance degree level of a commission project or the reliability degree level of a public solicitation subject entity.
(5) Disclosure subject entities may be limited in the case where some of the parameters to be taken into consideration when setting the importance degree level of a commission project is more than a certain threshold.
(6) A specific value may be automatically set to the parameters to be taken into consideration when setting the importance degree level of a commission project and the parameters to be taken into consideration when setting the reliability degree level of a public solicitation subject entity in the case where a value may not be set to such parameters because of a shortage of information or the like.
(7) The parameters to be taken into consideration when setting the reliability degree level of a public solicitation subject entity may be (7-1) manually input by the provider of the information processing apparatus 100, (7-2) automatically input from data accumulated by the provider of the information processing apparatus 100, or (7-3) automatically input from data disclosed by a third party.
(8) When comparing the importance degree level of a commission project and the reliability degree level of a public solicitation subject entity, the importance degree level and the reliability degree level that are the latest at the time of comparison may be referenced.
(9) Ties (correlates) the parameters to be taken into consideration when setting the importance degree level of a commission project to (with) the parameters to be taken into consideration when setting the reliability degree level of a public solicitation subject entity in accordance with the association degree. Compares the values of the tied parameters with each other. Accumulates the comparison results. A commission project may be disclosed to a public solicitation subject entity in the case where the accumulated value of a group of parameters to be taken into consideration when setting the reliability degree level of the public solicitation subject entity, as a result of the accumulation, is more than a threshold determined in advance.
(10) Ties one parameter to N parameters when tying the parameters to each other. The parameters in which one parameter is tied to N parameters may be accumulated as distributed in proportions determined in advance to calculate an accumulated value.

The information processing apparatus 100 may determine an appropriate disclosure subject entity for each commission project in accordance with parameters (indexes) set in advance.

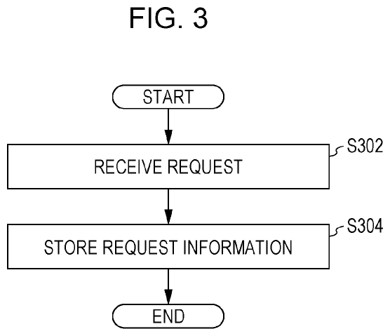

FIG. 3 is a flowchart illustrating a process example according to the exemplary embodiment (request content acquisition module 110).

In step S302, a request is received.

In step S304, request information is stored in the information storage module 170.

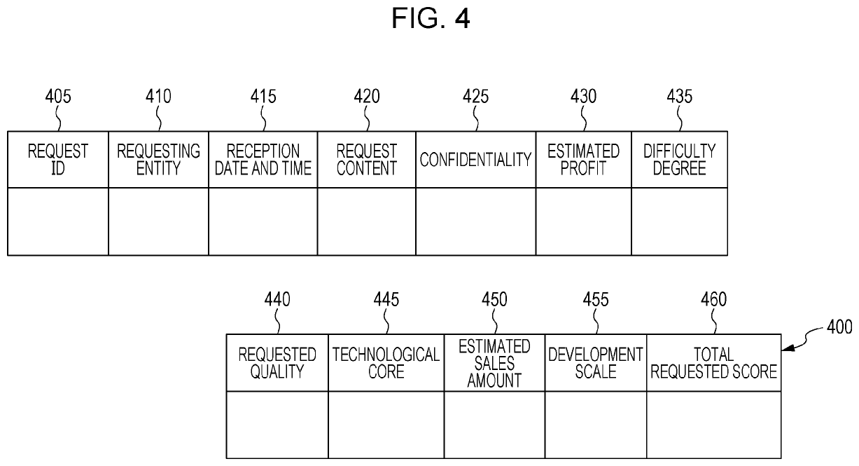

For example, the request information table 400 is received and stored. FIG. 4 illustrates a data structure example of the request information table 400. The request information table 400 has a request identification (ID) field 405, a requesting entity field 410, a reception date and time field 415, a request content field 420, a confidentiality field 425, an estimated profit field 430, a difficulty degree field 435, a requested quality field 440, a technological core field 445, an estimated sales amount field 450, a development scale field 455, and a total requested score field 460. The request ID field 405 stores information (request ID) for uniquely identifying a request in the exemplary embodiment. The requesting entity field 410 stores a requesting entity. The reception date and time field 415 stores the date and time (year, month, day, hour, minute, second, and sub-second or a combination thereof) when the request is received. The request content field 420 stores the content of the request. The confidentiality field 425 stores the confidentiality of the request. The estimated profit field 430 stores an estimated profit of the request. The difficulty degree field 435 stores the difficulty degree of the request. The requested quality field 440 stores the requested quality for the request. The technological core field 445 stores the technological core of the request. The estimated sales amount field 450 stores an estimated sales amount of the request. The development scale field 455 stores the development scale of the request. The total requested score field 460 stores the total requested score for the request. The value in the total requested score field 460 is an example of the first degree.

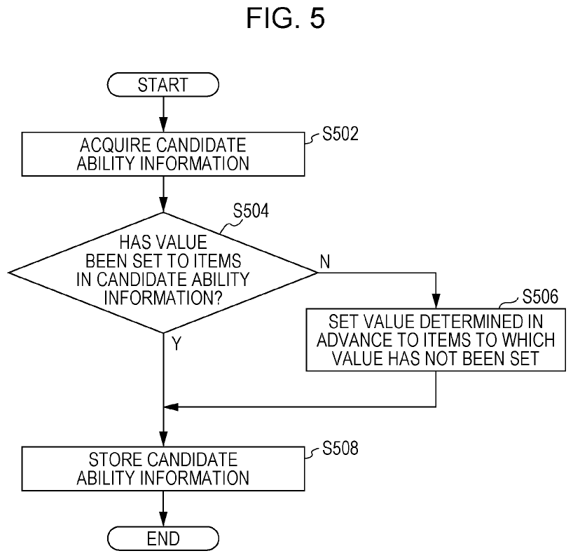

FIG. 5 is a flowchart illustrating a process example according to the exemplary embodiment (ability information acquisition module 130).

In step S502, candidate ability information is acquired. The candidate ability information (an example of the parameters to be taken into consideration when setting the second degree) may be (1) manually input by the provider of the information processing apparatus 100, (2) acquired from data accumulated by the provider of the information processing apparatus 100, and/or (3) acquired from data disclosed by a third party (e.g. the third-party evaluation server 250), for example.

In step S504, it is determined whether or not a value has been set to the items in the candidate ability information. In the case where a value has been set, the process proceeds to step S508. Otherwise, the process proceeds to step S506.

In step S506, a value determined in advance is set to the items to which a value has not been set. The value determined in advance may be the lowest value of the item, for example.

In step S508, the candidate ability information is stored in the information storage module 170.

The processes in steps S504 and S506 may be added after step S302 in the flowchart illustrated in the example in FIG. 3.

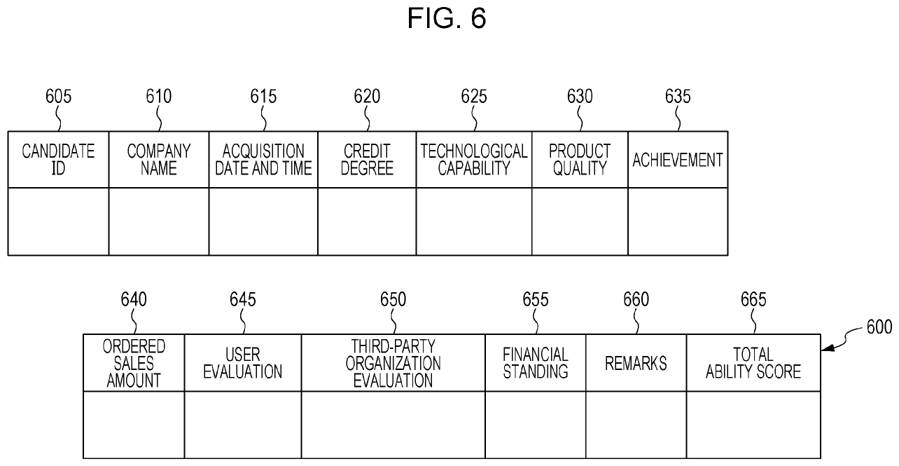

For example, the candidate ability information table 600 is acquired and stored. FIG. 6 illustrates a data structure example of the candidate ability information table 600. The candidate ability information table 600 has a candidate ID field 605, a company name field 610, an acquisition date and time field 615, a credit degree field 620, a technological capability field 625, a product quality field 630, an achievement field 635, an ordered sales amount field 640, a user evaluation field 645, a third-party organization evaluation field 650, a financial standing field 655, a remarks field 660, and a total ability score field 665. The candidate ID field 605 stores information (candidate ID) for uniquely identifying a contract candidate in the exemplary embodiment. The company name field 610 stores the company name of the contract candidate. The acquisition date and time field 615 stores the date and time when the data are acquired. The credit degree field 620 stores the credit degree of the contract candidate. The technological capability field 625 stores the technological capability of the contract candidate. The product quality field 630 stores the product quality achieved by the contract candidate. The achievement field 635 stores the achievements of the contract candidate. The ordered sales amount field 640 stores the ordered sales amount of the contract candidate. The user evaluation field 645 stores an evaluation of the contract candidate by the user. The third-party organization evaluation field 650 stores an evaluation of the contract candidate by a third-party organization. The financial standing field 655 stores the financial standing of the contract candidate. The remarks field 660 stores remarks on the contract candidate. The total ability score field 665 stores the total ability score of the contract candidate. The value in the total ability score field 665 is an example of the second degree.

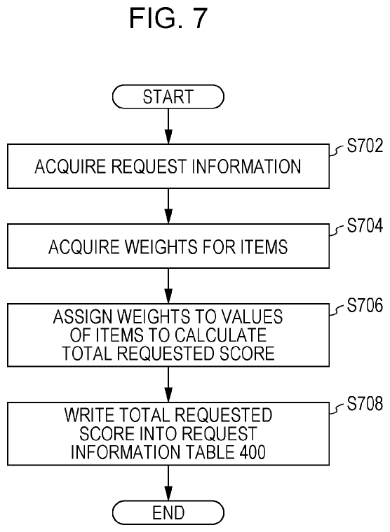

FIG. 7 is a flowchart illustrating a process example according to the exemplary embodiment (degree (A) setting module 120).

In step S702, the request information is acquired.

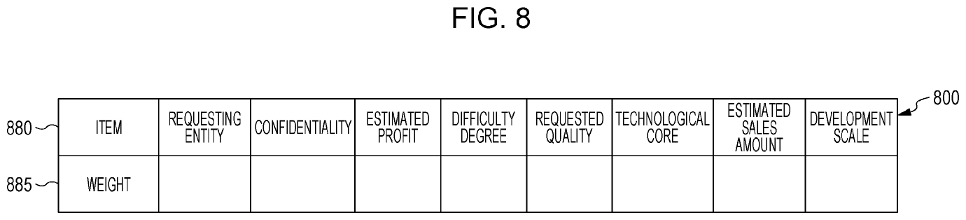

In step S704, weights for the items are acquired. For example, the request weight table 800 is acquired. FIG. 8 illustrates a data structure example of the request weight table 800. The request weight table 800 has an item field 880 and a weight field 885. The item field 880 stores items for calculation of a total requested score. The weight field 885 stores weights for such items.

In step S706, the weights are assigned to the values of the items to calculate a total requested score.

In step S708, the total requested score is written into the request information table 400 (total requested score field 460).

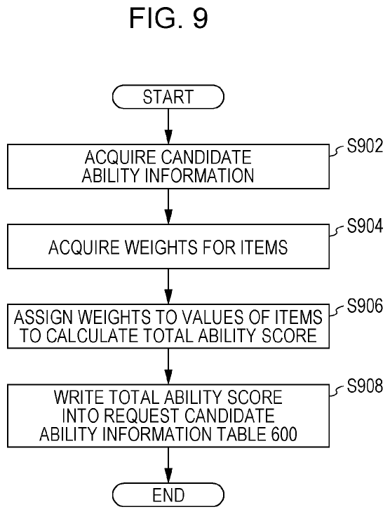

FIG. 9 is a flowchart illustrating a process example according to the exemplary embodiment (degree (B) setting module 140).

In step S902, candidate ability information is acquired.

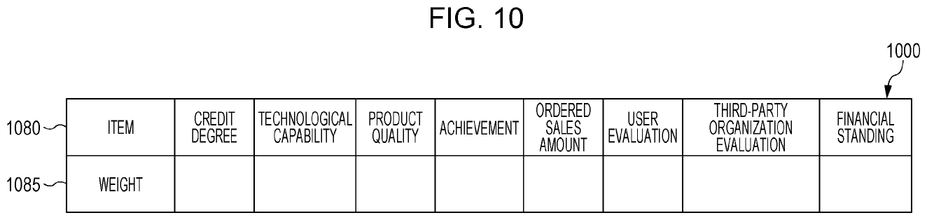

In step S904, weights for the items are acquired. For example, the ability weight table 1000 is acquired. FIG. 10 illustrates a data structure example of the ability weight table 1000. The ability weight table 1000 has an item field 1080 and a weight field 1085. The item field 1080 stores items for calculation of a total ability score. The weight field 1085 stores weights for such items.

In step S906, the weights are assigned to the values of the items to calculate a total ability score.

In step S908, the total ability score is written into the candidate ability information table 600 (total ability score field 665).

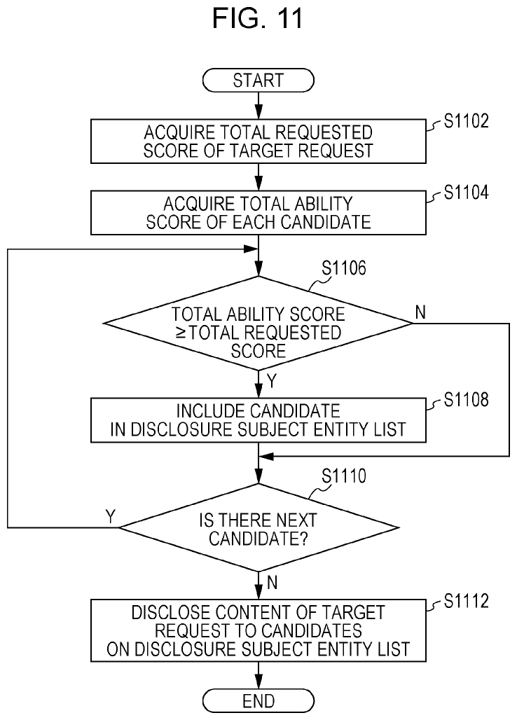

FIG. 11 is a flowchart illustrating a process example according to the exemplary embodiment (comparison module 150, disclosure module 160).

In step S1102, the total requested score of the target request is acquired.

In step S1104, the total ability score of each candidate is acquired.

In step S1106, it is determined whether or not “total ability score≥total requested score” holds true. In the case where “total ability score≥total requested score” holds true, the process proceeds to step S1108. Otherwise, the process proceeds to step S1110. In this process, the total ability score and the total requested score that are the latest at the time of comparison may be used. In the case where the parameters to be taken into consideration when setting the total requested score are acquired from data disclosed by a third party, further, the total requested score that is the latest at the time of comparison may be used when comparing the total ability score and the total requested score.

In step S1108, the candidate is included in a disclosure subject entity list.

In step S1110, it is determined whether or not there is a next candidate. In the case where there is a next candidate, the process returns to step S1106. Otherwise, the process proceeds to step S1112.

In step S1112, the content of the target request is disclosed to the candidates on the disclosure subject entity list.

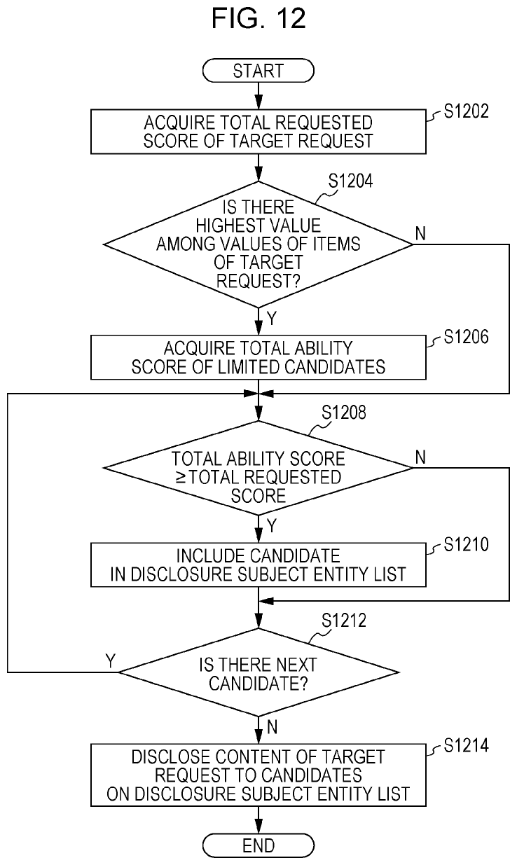

FIG. 12 is a flowchart illustrating a process example according to the exemplary embodiment (comparison module 150, disclosure module 160).

In step S1202, the total requested score of the target request is acquired.

In step S1204, it is determined whether or not there is a highest value among the values of the items of the target request. In the case where there is such a value, the process proceeds to step S1206. Otherwise, the process proceeds to step S1208. Examples of such a case include a case where the value of the confidentiality is its highest value “10”. In the process in step S1204, it may be “determined whether or not there is a highest value of an item determined in advance, among the items of the target request”. Specifically, the process proceeds to step S1206 only in the case where the value of the confidentiality discussed earlier is the highest value.

In step S1206, the total ability score of limited candidates is acquired. The “limited candidates” may be candidates (departments) of an organization to which the provider of the information processing apparatus 100 belongs, for example. It is highly possible that the requester makes a request with credit given to the information processing apparatus 100, and thus such a project (the value of the confidentiality of which is the highest value) should be committed to the company of the information processing apparatus 100.

In step S1208, it is determined whether or not “total ability score≥total requested score” holds true. In the case where “total ability score total requested score” holds true, the process proceeds to step S1210. Otherwise, the process proceeds to step S1212.

In step S1210, the candidate is included in a disclosure subject entity list.

In step S1212, it is determined whether or not there is a next candidate. In the case where there is a next candidate, the process returns to step S1208. Otherwise, the process proceeds to step S1214.

In step S1214, the content of the target request is disclosed to the candidates on the disclosure subject entity list.

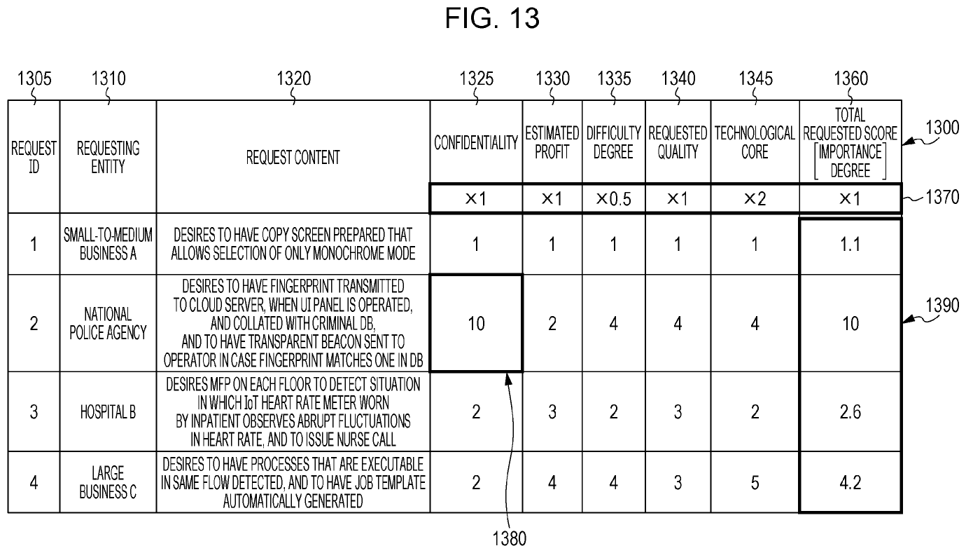

A specific example will be described with reference to the example in FIGS. 13 to 18.

FIG. 13 illustrates a data structure example of the request information table 1300. The request information table 1300 is obtained by combining the request information table 400 and the request weight table 800.

The request information table 1300 has a request ID field 1305, a requesting entity field 1310, a request content field 1320, a confidentiality field 1325, an estimated profit field 1330, a difficulty degree field 1335, a requested quality field 1340, a technological core field 1345, and a total requested score [importance degree] field 1360. The request ID field 1305 stores a request ID. The requesting entity field 1310 stores the requesting entity which makes the request. The request content field 1320 stores the content of the request. The confidentiality field 1325 stores the confidentiality of the request. The estimated profit field 1330 stores an estimated profit of the request. The difficulty degree field 1335 stores the difficulty degree of the request. The requested quality field 1340 stores the requested quality for the request. The technological core field 1345 stores the technological core of the request. The total requested score [importance degree] field 1360 stores the total requested score for the request. The values in the confidentiality field 1325 to the technological core field 1345 are parameters for determining the total requested score (importance degree level) of the request.

A weight assignment field 1370 indicates a weight assigned to each parameter. The value of the assigned weight is changeable.

In this example, the weight assignment field 1370 applies a weight of 1 to the value in the confidentiality field 1325, applies a weight of 1 to the value in the estimated profit field 1330, applies a weight of 0.5 to the value in the difficulty degree field 1335, applies a weight of 1 to the value in the requested quality field 1340, applies a weight of 2 to the value in the technological core field 1345, and applies a weight of 1 to the value in the total requested score [importance degree] field 1360. While a weight is assigned to the value in the total requested score [importance degree] field 1360, a weight may not be assigned to the value in the total requested score [importance degree] field 1360.

For example, the request with a request ID of 1 has “small-to-medium business A” as the requesting entity, “desires to have a copy screen prepared that allows selection of only the monochrome mode” as the request content, a value of “1” as the confidentiality, a value of “1” as the estimated profit, a value of “1” as the difficulty degree, a value of “1” as the requested quality, a value of “1” as the technological core, and a value of “1.1” as the total requested score [importance degree]. The [importance degree] is calculated as (1×1+1×1+1×0.5+1×1+1×2)/5=1.1. The value is rounded off to the first decimal place (the same also applies hereinafter).

The request with a request ID of 2 has “National Police Agency” as the requesting entity, “desires to have a fingerprint transmitted to a cloud server, when a user interface (UI) panel is operated, and collated with a criminal database (DB), and to have a transparent beacon sent to the operator in the case where the fingerprint matches one in the DB” as the request content, a value of “10” as the confidentiality, a value of “2” as the estimated profit, a value of “4” as the difficulty degree, a value of “4” as the requested quality, a value of “4” as the technological core, and a value of “10” as the total requested score [importance degree].

If any of the parameters to be taken into consideration when setting the importance degree level has “10” (highest value) as in a specific item 1380 (the confidentiality field 1325 of the request with a request ID of 2), the importance degree level (total score) is set to “10” so that the request is disclosed to only limited public solicitation subject entities. The limited public solicitation subject entities may be in-house departments of the company of the information processing apparatus 100 etc. as discussed earlier.

The request with a request ID of 3 has “hospital B” as the requesting entity, “desires a multi-function peripheral (MFP) on each floor to detect a situation in which an Internet-of-Things (IoT) heart rate meter worn by an inpatient observes abrupt fluctuations in the heart rate, and to issue a nurse call” as the request content, a value of “2” as the confidentiality, a value of “3” as the estimated profit, a value of “2” as the difficulty degree, a value of “3” as the requested quality, a value of “2” as the technological core, and a value of “2.6” as the total requested score [importance degree]. The [importance degree] is calculated as (2×1+3×1+2×0.5+3×1+2×2)/5=2.6.

The request with a request ID of 4 has “large business C” as the requesting entity, “desires to have processes that are executable in the same flow detected, and to have a job template automatically generated” as the request content, a value of “2” as the confidentiality, a value of “4” as the estimated profit, a value of “4” as the difficulty degree, a value of “3” as the requested quality, a value of “5” as the technological core, and a value of “4.2” as the total requested score [importance degree]. The [importance degree] is calculated as (2×1+4×1+4×0.5+3×1+5×2)/5=4.2.

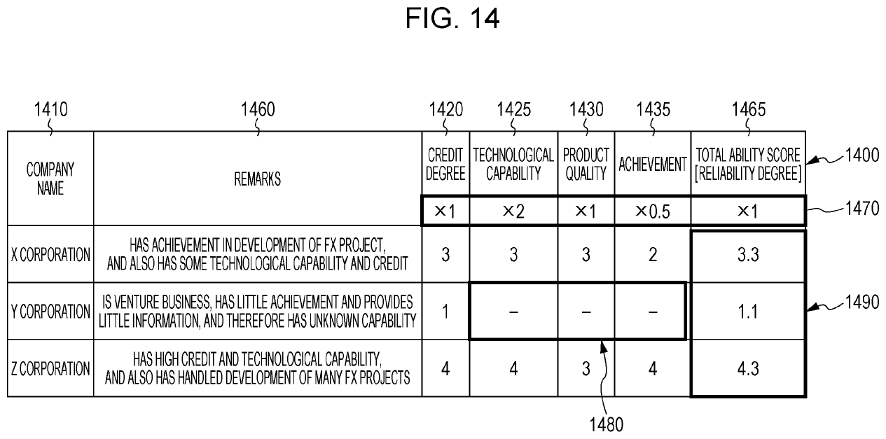

FIG. 14 illustrates a data structure example of the candidate ability information table 1400. The candidate ability information table 1400 is obtained by combining the candidate ability information table 600 and the ability weight table 1000.

The candidate ability information table 1400 has a company name field 1410, a remarks field 1460, a credit degree field 1420, a technological capability field 1425, a product quality field 1430, an achievement field 1435, and a total ability score [reliability degree] field 1465. The company name field 1410 stores the company name of a commission candidate. The remarks field 1460 stores remarks on the commission candidate. The credit degree field 1420 stores the credit degree of the commission candidate. The technological capability field 1425 stores the technological capability of the commission candidate. The product quality field 1430 stores the product quality achieved by the commission candidate. The achievement field 1435 stores the achievements of the commission candidate. The total ability score field [credit degree] 1465 stores the total ability score of the commission candidate. The values in the credit degree field 1420 to the achievement field 1435 are parameters for determining the reliability degree level.

A weight assignment field 1470 indicates a weight assigned to each parameter. The value of the assigned weight is changeable.

The weight assignment field 1470 applies a weight of 1 to the value in the credit degree field 1420, applies a weight of 2 to the value in the technological capability field 1425, applies a weight of 1 to the value in the product quality field 1430, applies a weight of 0.5 to the value in the achievement field 1435, and applies a weight of 1 to the value in the total ability score [reliability degree] field 1465. While a weight is assigned to the value in the total ability score [reliability degree] field 1465, a weight may not be assigned to the value in the total ability score [reliability degree] field 1465.

For example, the company with a company name of X corporation has “has an achievement in the development of an FX project, and also has some technological capability and credit” as the remarks, a value of “3” as the credit degree, a value of “3” as the technological capability, ax value of “3” as the technological capability, a value of “2” as the achievement, and a value of “3.3” as the total ability score [credit degree]. The [credit degree] is calculated as (3×1+3×2+2×2+2×0.5)/4=3.3.

The company with a company name of Y corporation has “is a venture business, has little achievement and provides little information, and therefore has an unknown capability” as the remarks, a value of “1” as the credit degree, a value of “-” as the technological capability, a value of “-” as the product quality, a value of “-” as the achievement, and a of “1.1” as the total ability score [credit degree] value. A specific value may be set to parameters (fields with a “-” symbol), to which a value may not be set because of a shortage of information or the like. In the case of this example, a value of “1” is automatically assigned. Thus, the [credit degree] is calculated as (1×1+1×2+1×2+1×0.5)/4=1.1.

The company with a company name of Z corporation has “has high credit and technological capability, and also has handled the development of many FX projects” as the remarks, a value of “4” as the credit degree, a value of “4” as the technological capability, a value of “3” as the product quality, a value of “4” as the achievement, and a value of “4.3” as the total ability score [credit degree]. The [credit degree] is calculated as (4×1+4×2+3×2+4×0.5)/4=4.3.

A request that meets the following formula is disclosed to each commission candidate.

Importance degree of requested project credit degree of commission candidate

Specifically,
the requests with a request ID of 1 and a request ID of 3 are disclosed to X corporation;
the request with a request ID of 1 is disclosed to Y corporation; and
the requests with a request ID of 1, a request ID of 3, and a request ID of 4 are disclosed to Z corporation.

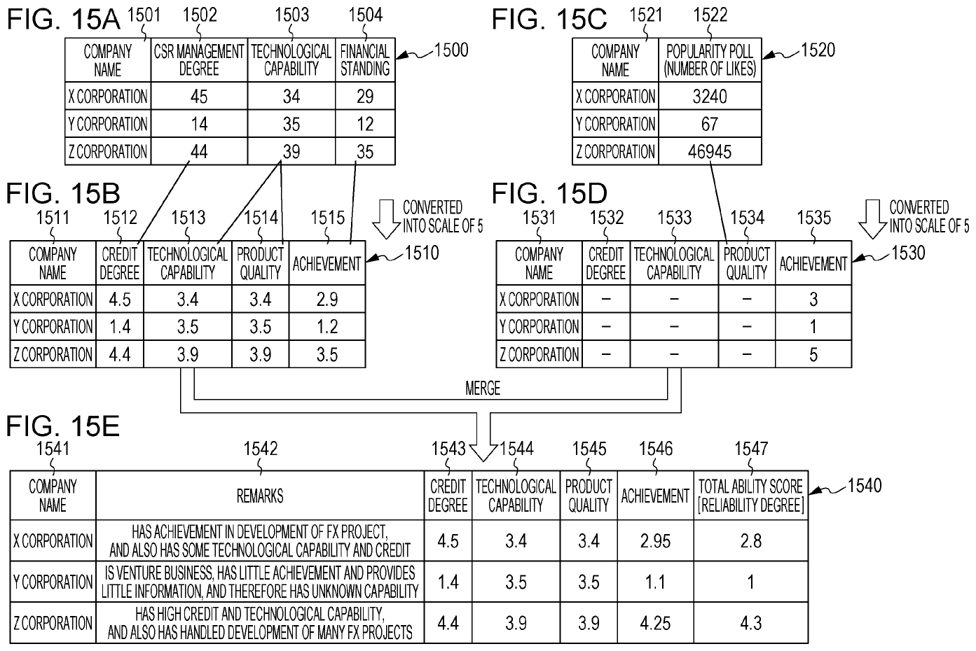

FIGS. 15A to 15E illustrate a process example according to the exemplary embodiment. An example in which parameters to be taken into consideration when setting the credit degree are acquired from data disclosed by a third party will be described. Data corresponding to the necessary parameters are not necessarily present in the data which are disclosed by a third party. Thus, the following process is performed.

FIG. 15A illustrates a data structure example of the rating company (A) evaluation information table 1500.

The rating company (A) evaluation information table 1500 contains evaluation data disclosed by a third party, and has a company name field 1501, a corporate social responsibility (CSR) management degree field 1502, a technological capability field 1503, and a financial standing field 1504. The company name field 1501 stores a company name. The CSR management degree field 1502 stores a CSR management degree. The technological capability field 1503 stores a technological capability. The financial standing field 1504 stores a financial standing.

The timing when the information processing apparatus 100 references the rating company (A) evaluation information table 1500 is once in six months (low update frequency).

FIG. 15B illustrates a data structure example of the candidate ability information table 1510. The candidate ability information table 1510 contains a group of parameters used when the information processing apparatus 100 sets a credit degree.

The candidate ability information table 1510 has a company name field 1511, a credit degree field 1512, a technological capability field 1513, a product quality field 1514, and an achievement field 1515. The company name field 1511 stores a company name. The credit degree field 1512 stores a credit degree. The technological capability field 1513 stores a technological capability. The product quality field 1514 stores a product quality. The achievement field 1515 stores an achievement.

The CSR management degree field 1502 has been replaced with the credit degree field 1512, the technological capability field 1503 has been replaced with the technological capability field 1513 and the product quality field 1514, and the financial standing field 1504 has been replaced with the achievement field 1515. The evaluation values have been converted into a scale of 5.

FIG. 15C illustrates a data structure example of the rating company (B) evaluation information table 1520.

The rating company (B) evaluation information table 1520 contains evaluation data disclosed by a different third party, and has a company name field 1521 and a popularity poll (number of likes) field 1522. The company name field 1521 stores a company name. The popularity poll (number of likes) field 1522 stores a value based on a popularity poll (number of likes).

FIG. 15D illustrates a data structure example of the candidate ability information table 1530. The candidate ability information table 1530 contains a group of parameters used when the information processing apparatus 100 sets a credit degree.

The candidate ability information table 1530 has a company name field 1531, a credit degree field 1532, a technological capability field 1533, a product quality field 1534, and an achievement field 1535. The company name field 1531 stores a company name. The credit degree field 1532 stores a credit degree. The technological capability field 1533 stores a technological capability. The product quality field 1534 stores a product quality. The achievement field 1535 stores an achievement.

The popularity poll (number of likes) field 1522 has been replaced with the product quality field 1534. The evaluation values have been converted into a scale of 5.

The timing when the information processing apparatus 100 references the candidate ability information table 1530 is real time (high update frequency).

FIG. 15E illustrates a data structure example of the candidate ability information table 1540. The candidate ability information table 1540 is generated by merging the candidate ability information table 1510 and the candidate ability information table 1530.

The candidate ability information table 1540 has a company name field 1541, a remarks field 1542, a credit degree field 1543, a technological capability field 1544, a product quality field 1545, an achievement field 1546, and a total ability score [reliability degree] field 1547. The company name field 1541 stores a company name. The remarks field 1542 stores remarks. The credit degree field 1543 stores a credit degree. The technological capability field 1544 stores a technological capability. The product quality field 1545 stores a product quality. The achievement field 1546 stores an achievement. Specifically, the achievement field 1546 has a value obtained by averaging the values in the achievement field 1515 and the achievement field 1535. The total ability score [reliability degree] field 1547 stores a total ability score [credit degree].

The values of the parameters may be (1) manually input by the provider of the information processing apparatus 100, (2) input from data accumulated in the information processing apparatus 100, or (3) input from data disclosed by a reliable third party.

When a commission candidate searches for a commission project, a comparison may be made using the credit degree of the commission candidate and the importance degree of the commission project that are the latest at the time of the search.

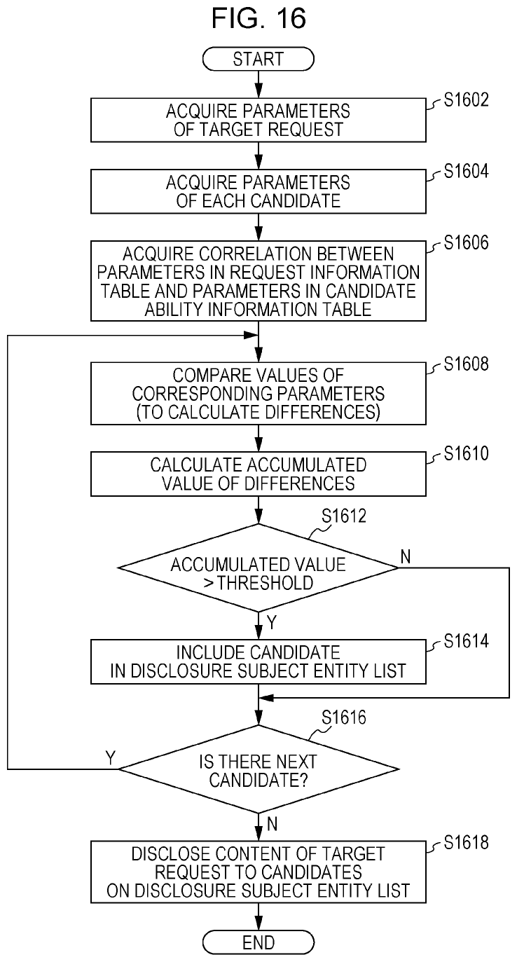

FIG. 16 is a flowchart illustrating a process example according to the exemplary embodiment.

In step S1602, the parameters of a target request (corresponding to the parameters to be taken into consideration when setting the first degree discussed earlier) are acquired.

In step S1604, the parameters of each candidate (corresponding to the parameters to be taken into consideration when setting the second degree discussed earlier) are acquired.

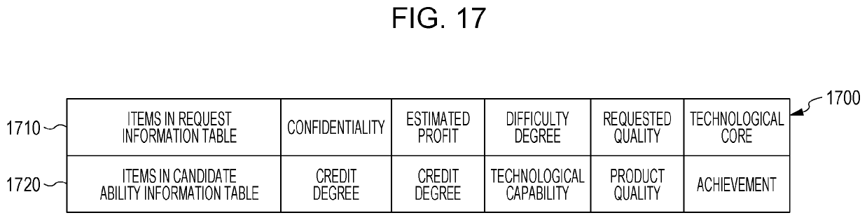

In step S1606, correlation between the parameters (items) in the request information table and the parameters in the candidate ability information table is acquired. For example, the correlation table 1700 is acquired. FIG. 17 illustrates a data structure example of the correlation table 1700. The correlation table 1700 has an item field 1710 for the items in the request information table 400 and an item field 1720 for the items in the candidate ability information table 600. The item field 1710 for the items in the request information table 400 stores the items in the request information table. The item field 1720 for the items in the candidate ability information table 600 stores the items in the candidate ability information table.

Specifically, the table indicates that the confidentiality field 425 and the estimated profit field 430 correspond to the credit degree field 620, the difficulty degree field 435 corresponds to the technological capability field 625, the requested quality field 440 corresponds to the product quality field 630, and the technological core field 445 corresponds to the achievement field 635.

In step S1608, the values of the corresponding parameters are compared (to calculate respective differences).

In step S1610, an accumulated value of the differences is calculated.

In step S1612, it is determined whether or not “accumulated value>threshold” holds true. In the case where “accumulated value>threshold” holds true, the process proceeds to step S1614. Otherwise, the process proceeds to step S1616.

In step S1614, the candidate is included in a disclosure subject entity list.

In step S1616, it is determined whether or not there is a next candidate. In the case where there is a next candidate, the process returns to step S1608. Otherwise, the process proceeds to step S1618.

In step S1618, the content of the target request is disclosed to the candidates on the disclosure subject entity list.

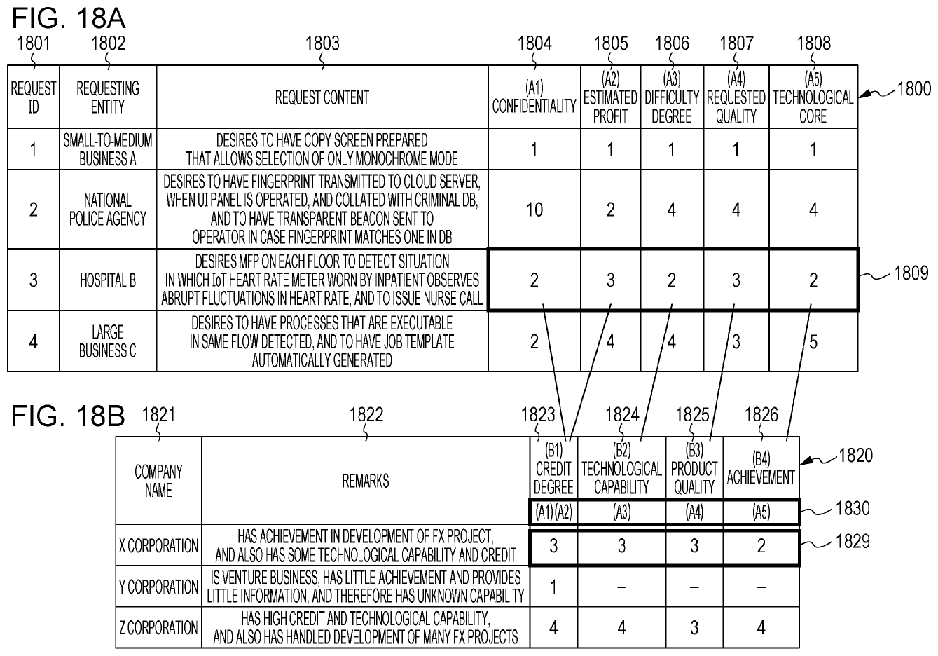

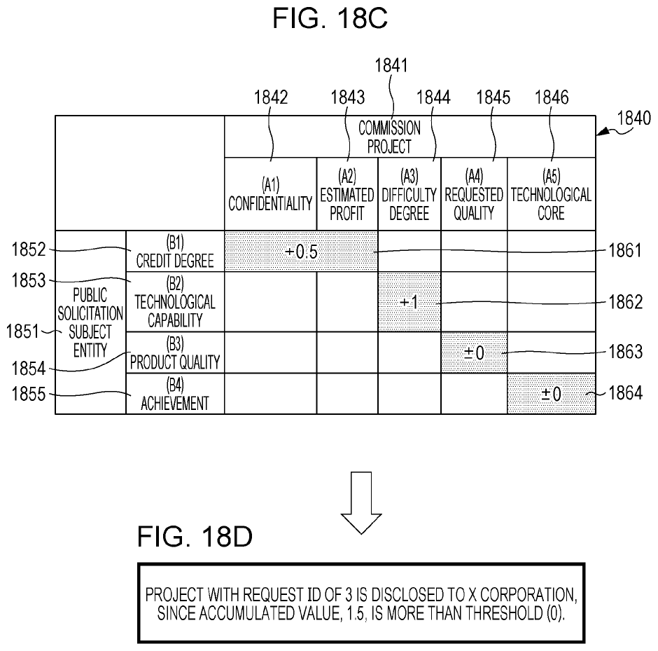

FIG. 18 illustrates a process example according to the exemplary embodiment.

FIG. 18A illustrates a data structure example of the request information table 1800.

The request information table 1800 is a commission project database (importance degree: 1 to 5 (disclosed); 10 (disclosed to limited entities)). The request information table 1800 is obtained by removing the weight assignment field 1370 from the request information table 1300 illustrated in the example in FIG. 13. The weight assignment field 1370 may be added to the request information table 1800.

The request information table 1800 has a request ID field 1801, a requesting entity field 1802, a request content field 1803, a confidentiality field 1804, an estimated profit field 1805, a difficulty degree field 1806, a requested quality field 1807, and a technological core field 1808. The request ID field 1801 stores a request ID. The requesting entity field 1802 stores a requesting entity. The request content field 1803 stores the content of the request. The confidentiality field 1804 stores confidentiality. The estimated profit field 1805 stores an estimated profit. The difficulty degree field 1806 stores a difficulty degree. The requested quality field 1807 stores a requested quality. The technological core field 1808 stores a technological core.

FIG. 18B illustrates a data structure example of the candidate ability information table 1820.

The candidate ability information table 1820 is a public solicitation subject entity database (credit degree: 1 to 5). The candidate ability information table 1820 is obtained by removing the weight assignment field 1470 from the candidate ability information table 1400 illustrated in the example in FIG. 14. The weight assignment field 1470 may be added to the candidate ability information table 1820.

The candidate ability information table 1820 has a company name field 1821, a remarks field 1822, a credit degree field 1823, a technological capability field 1824, a product quality field 1825, and an achievement field 1826. The company name field 1821 stores a company name. The remarks field 1822 stores remarks. The credit degree field 1823 stores a credit degree. The technological capability field 1824 stores a technological capability. The product quality field 1825 stores a product quality. The achievement field 1826 stores an achievement.

A correlation field 1830 stores the content of the correlation table 1700 illustrated in the example in FIG. 17. According to the correlation, the confidentiality field 1804 and the estimated profit field 1805 correspond to the credit degree field 1823, the difficulty degree field 1806 corresponds to the technological capability field 1824, the requested quality field 1807 corresponds to the product quality field 1825, and the technological core field 1808 corresponds to the achievement field 1826.

Next, as illustrated in the example in FIGS. 18C and 18D, a comparison is made between the correlated parameters (a target item field 1809 and target items 1829), the comparison results are accumulated, and the content of the request of the project with a request ID of 3 is disclosed to X corporation in the case where the accumulated value is more than, or equal to or more than, a threshold determined in advance. That is, a comparison is made between the corresponding parameters, the superiority of the public solicitation subject entity level to the commission project level is calculated and accumulated, and the content of the commission project is disclosed in the case where the accumulated value is more than (or equal to or more than) a threshold.

FIG. 18C illustrates a data structure example of the comparison result table 1840.

The comparison result table 1840 indicates an example of the result of comparing the corresponding parameters for determining whether or not to disclose the project with a request ID of 3 to X corporation.

The comparison result table 1840 has a commission project field 1841 in the column direction and a public solicitation subject entity field 1851 in the row direction. The commission project field 1841 has a confidentiality field 1842, an estimated profit field 1843, a difficulty degree field 1844, a requested quality field 1845, and a technological core field 1846. The public solicitation subject entity field 1851 has a credit degree field 1852, a technological capability field 1853, a product quality field 1854, and an achievement field 1855.

Comparison results 1861 to 1864 store values obtained by subtracting the values of the parameters in the target item field 1809 from the values of the corresponding parameters in the target items 1829. Specifically, the comparison result 1861 for the credit degree field 1852 corresponding to the confidentiality field 1842 and the estimated profit field 1843 is “+0.5”, the comparison result 1862 for the technological capability field 1853 corresponding to the difficulty degree field 1844 is “+1”, the comparison result 1863 for the product quality field 1854 corresponding to the requested quality field 1845 is “±0”, and the comparison result 1864 for the achievement field 1855 corresponding to the technological core field 1846 is “±0”.

In the comparison result 1861, the parameters are correlated with each other such that one parameter is correlated with two parameters. In this case, a comparison is made using the result of integrating the parameters in the confidentiality field 1804 and the estimated profit field 1805 as distributed in proportions determined in advance (in this example, 0.5 each). Specifically, the value “+0.5” as the comparison result 1861 is calculated as 3−(2×0.5+3×0.5). The proportions for distribution may be equal proportions (i.e. 1/N), or may be proportions determined in advance.

In the example in FIG. 18D, the comparison results in FIG. 18C are accumulated (0.5+1+0+0=1.5), and a determination result “The project with a request ID of 3 is disclosed to X corporation, since the accumulated value, 1.5, is more than the threshold (0).” is displayed to the user. After a final instruction for disclosure is received from the user, the project with a request ID of 3 is disclosed to X corporation. Alternatively, a disclosure may be made in accordance with the determination result without a final instruction from the user.

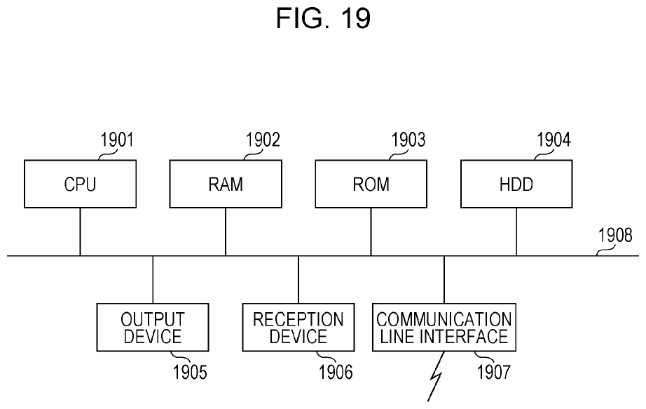

As illustrated in FIG. 19, the hardware configuration of a computer that executes a program as the exemplary embodiment is a common computer, specifically a computer that may serve as a personal computer, a server, or the like. That is, as a specific example, the computer includes a CPU 1901 as a processing section (computation section) and a RAM 1902, a read only memory (ROM) 1903, and a hard disk drive (HDD) 1904 as storage devices. The HDD 1904 may be a hard disk drive or a solid state drive (SSD) which is a flash memory, for example. The computer is composed of: the CPU 1901 which executes programs such as the request content acquisition module 110, the degree (A) setting module 120, the ability information acquisition module 130, the degree (B) setting module 140, the comparison module 150, and the disclosure module 160; the RAM 1902 which stores the programs and data; the ROM 1903 which stores a program for starting the computer etc.; the HDD 1904 which is an auxiliary storage device that has the function as the information storage module 170 etc.; a reception device 1906 that receives data on the basis of an operation (including motion, a voice, a line of sight, etc.) performed by the user on a keyboard, a mouse, a touch screen, a microphone, a camera (including a line-of-sight detection camera etc.), or the like; an output device 1905 such as a CRT, a liquid crystal display, a speaker, etc.; a communication line interface 1907 for connection with a communication network such as a network interface card; and a bus 1908 that connects such components for data exchange. A plurality of such computers may be connected to each other through a network.

The exemplary embodiment discussed earlier implemented by a computer program is implemented by causing a system of the hardware configuration described above to read the computer program as software and causing the software and hardware resources to cooperate with each other.

The hardware configuration illustrated in FIG. 19 indicates one configuration example. The exemplary embodiment is not limited to the configuration illustrated in FIG. 19, and may have any configuration that may execute the modules described in relation to the exemplary embodiment. For example, some of the modules may be constituted by dedicated hardware (such as an application specific integrated circuit (ASIC), for example), some of the modules may be provided in an external system and connected through a communication line, and further a plurality of systems illustrated in FIG. 19 may be connected to each other through a communication line to cooperate with each other. In addition, and in particular, the system may be incorporated into not only a personal computer but also a portable information communication device (including a cellular phone, a smartphone, a mobile device, a wearable computer, etc.), an information appliance, a robot, a copier, a facsimile, a scanner, a printer, a multi-function device (image processing apparatus that has the functions of two or more of a scanner, a printer, a copier, a facsimile, etc.), etc.

The phrases “equal to or more than”, “equal to or less than”, “more than”, and “less than” used in the description of the comparison process according to the exemplary embodiment discussed earlier may be replaced with phrases “more than”, “less than”, “equal to or more than”, and “equal to or less than”, respectively, unless any contradiction occurs with the combination of such phrases.

The program described above may be provided as stored in a storage medium, or the program may be provided by a communication unit. In this case, the program described above may be considered as a “computer-readable storage medium that stores a program”, for example.

The term “computer-readable storage medium that stores a program” refers to a computer-readable storage medium that stores a program and that is used to install, execute, and distribute the program.

Examples of the storage medium include digital versatile discs (DVDs) that conform to standards prescribed by the DVD Forum “DVD-R, DVD-RW, DVD-RAM, etc.”, DVDs that conform to standards prescribed by the DVD+RW Alliance “DVD+R, DVD+RW, etc.”, compact discs (CDs) such as read-only memory (CD-ROM), CD recordable (CD-R), and CD rewritable (CD-RW), Blu-ray (registered trademark) discs, magneto-optical (MO) disks, flexible disks (FDs), magnetic tapes, hard disks, read-only memories (ROMs), electrically erasable reprogrammable read-only memories (EEPROMs (registered trademark)), flash memories, random-access memories (RAMs), and SD (Secure Digital) memory cards.

A part or all of the program described above may be saved, distributed, etc. as stored in the storage medium. In addition, a part or all of the program may be transferred through communication using a transfer medium such as a wired network, a wireless communication network, or a combination thereof used for a local area network (LAN), a metropolitan area network (MAN), a wide area network (WAN), the Internet, an intranet, an extranet, etc., or may be carried over a carrier wave.

Further, the program described above may be a part or all of another program, or may be stored in a storage medium together with another program. Alternatively, the program may be stored as divided in a plurality of storage media. In addition, the program may be compressed, encrypted, stored, etc. in any form as long as the program may be restored.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising a disclosure unit that discloses a content of a request indicated by a first degree to a person with an ability indicated by a second degree in a case where the first degree which indicates the content of the request is equal to or less than the second degree which indicates the ability of the person who possibly undertakes the request.

2. The information processing apparatus according to claim 1, further comprising
a first setting unit that sets the first degree,
wherein the first setting unit uses some or all of a requesting entity, confidentiality, a difficulty degree, a requested quality, a technological core, an estimated profit, an estimated sales amount, and a development scale as parameters to be taken into consideration when setting the first degree.

3. The information processing apparatus according to claim 1, further comprising
a second setting unit that sets the second degree,
wherein the second setting unit uses some or all of a credit degree, technological capability, a product quality, an achievement, an ordered sales amount, a user evaluation, a third-party organization evaluation, and a financial standing as parameters to be taken into consideration when setting the second degree.

4. The information processing apparatus according to claim 2,
wherein the first setting unit or the second setting unit assigns a weight to some or all of the parameters to be taken into consideration when setting the first degree or the second degree.

5. The information processing apparatus according to claim 2,
the disclosure unit limits disclosure subject entities in a case where some of the parameters to be taken into consideration when setting the first degree are higher than, or equal to or higher than, a threshold determined in advance.

6. The information processing apparatus according to claim 2,
wherein the first setting unit or the second setting unit sets the first degree or the second degree using a value determined in advance in a case where a value of the parameters is not set.

7. The information processing apparatus according to claim 2,
wherein the parameters to be taken into consideration when setting the second degree are manually input by a provider of the information processing apparatus, acquired from data accumulated by the provider of the information processing apparatus, and/or acquired from data disclosed by a third party.

8. The information processing apparatus according to claim 1, further comprising
a comparison unit that compares the first degree and the second degree,
wherein the comparison unit uses the first degree and the second degree that are latest at a time of comparison when comparing the first degree and the second degree.

9. The information processing apparatus according to claim 8,
wherein the comparison unit uses the second degree that is the latest at the time of comparison when comparing the first degree and the second degree in a case where the parameters to be taken into consideration when setting the second degree are acquired from data disclosed by a third party.

10. An information processing apparatus comprising:
a correlation unit that correlates parameters to be taken into consideration when setting a first degree that indicates a content of a request with parameters to be taken into consideration when setting a second degree that indicates an ability of a person that possibly undertakes the request;
a comparison unit that compares the correlated parameters with each other;
an accumulation unit that accumulates comparison results; and
a disclosure unit that discloses the content of the request to the person in a case where an accumulated value of the accumulated results is more than, or equal to or more than, a threshold determined in advance.

11. The information processing apparatus according to claim 10,
wherein the correlation unit correlates the parameters such that one parameter is correlated with N parameters, and
the comparison unit makes a comparison using a result of integrating the N parameters, among the parameters in which one parameter is correlated with N parameters, as distributed in proportions determined in advance.

12. A non-transitory computer readable medium storing a program causing a computer to execute a process for information processing, the process comprising
disclosing a content of a request indicated by a first degree to a person with an ability indicated by a second degree in a case where the first degree which indicates the content of the request is equal to or less than the second degree which indicates the ability of the person who possibly undertakes the request.

13. An information processing apparatus comprising
a disclosure means for disclosing a content of a request indicated by a first degree to a person with an ability indicated by a second degree in a case where the first degree which indicates the content of the request is equal to or less than the second degree which indicates the ability of the person who possibly undertakes the request.
